(19) United States
(12) Patent Application Publication
(10) Pub. No.: US 2016/0055434 A1
(43) Pub. Date: Feb. 25, 2016

(54) DYNAMIC RISK ASSESSMENT BASED PRODUCT SAMPLING

(71) Applicant: LENOVO ENTERPRISE SOLUTIONS (SINGAPORE) PTE. LTD., NEW TECH PARK (SG)

(72) Inventors: Ivory W. Knipfer, Rochester, MN (US); Jie Li, Shenzhen (CN); Junwu Sun, Shenzhen (CN); Matthew H. Zemke, Rochester, MN (US)

(21) Appl. No.: 14/465,083

(22) Filed: Aug. 21, 2014

(51) Int. Cl. G06Q 10/06

(52) U.S. Cl. CPC G06Q 10/0635

(57) ABSTRACT

In a method, system, and computer program product for dynamic risk assessment based product sampling, for a product to be produced in response to an order for the product, a processing flow comprising a plurality of stages for producing the product is determined. A set of conditions expected to be present at a time of executing a stage in the plurality of stages is identified. A risk model corresponding to a subset of the set of conditions is selected. A failure mode related to the risk model is selected. The failure mode is applied to the risk model using the subset of conditions to compute a risk value associated with the product. The product is selected as a sample for the stage responsive to the risk value exceeding a threshold risk value.

### TECHNICAL FIELD

The present invention relates generally to a method, system, and computer program product for selecting samples of products for quality and other testing. More particularly, the present invention relates to a method, system, and computer program product for dynamic risk assessment based product sampling.

### BACKGROUND

Customers place orders for products. A manufacturing facility makes a product according to the specification of the customer who ordered that product, a standard specification of a product, or both.

A manufacturing facility typically manufactures a large number of products in this manner. Some products are selected as samples for quality testing and other purposes. For example, a presently used sampling process selects for quality testing and other purposes every n-th product that is manufactured in this manner. Another example sampling process randomly selects a product for a similar purpose.

### SUMMARY

The illustrative embodiments provide a method, system, and computer program product for dynamic risk assessment based product sampling. An embodiment includes a method for dynamic risk assessment based product sampling. The embodiment determines, for a product to be produced in response to an order for the product, a processing flow comprising a plurality of stages for producing the product. The embodiment identifies a set of conditions expected to be present at a time of executing a stage in the plurality of stages. The embodiment selects a risk model corresponding to a subset of the set of conditions. The embodiment selects a failure mode related to the risk model. The embodiment applies the failure mode to the risk model using the subset of conditions to compute a risk value associated with the product. The embodiment selects the product as a sample for the stage responsive to the risk value exceeding a threshold risk value.

Another embodiment includes a computer readable article of manufacture tangibly embodying a computer readable instructions which, when executed, cause a computer to carry out steps of a method for dynamic risk assessment based product sampling. The embodiment determines, for a product to be produced in response to an order for the product, a processing flow comprising a plurality of stages for producing the product. The embodiment identifies a set of conditions expected to be present at a time of executing a stage in the plurality of stages. The embodiment selects a risk model corresponding to a subset of the set of conditions. The embodiment selects a failure mode related to the risk model. The embodiment applies the failure mode to the risk model using the subset of conditions to compute a risk value associated with the product. The embodiment selects the product as a sample for the stage responsive to the risk value exceeding a threshold risk value.

Another embodiment includes a data processing system for dynamic risk assessment based product sampling. The embodiment further includes a storage device including a storage medium, wherein the storage device stores computer usable program code. The embodiment further includes a processor, wherein the processor executes the computer usable program code. The embodiment further includes computer usable code for determining, for a product to be produced in response to an order for the product, a processing flow comprising a plurality of stages for producing the product. The embodiment further includes computer usable code for identifying a set of conditions expected to be present at a time of executing a stage in the plurality of stages. The embodiment further includes computer usable code for selecting a risk model corresponding to a subset of the set of conditions. The embodiment further includes computer usable code for selecting a failure mode related to the risk model. The embodiment further includes computer usable code for applying the failure mode to the risk model using the subset of conditions to compute a risk value associated with the product. The embodiment further includes computer usable code for selecting the product as a sample for the stage responsive to the risk value exceeding a threshold risk value.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts an example table correlating example processing flow stages with example risk models for dynamic risk assessment based product sampling in accordance with an illustrative embodiment;

FIG. 4 depicts an example tabular representation of correlations between circumstances, risk models, and failure modes usable for dynamic risk assessment based product sampling in accordance with an illustrative embodiment; and

FIG. 5 depicts a flowchart of an example process for dynamic risk assessment based product sampling in accordance with an illustrative embodiment.

### DETAILED DESCRIPTION

Customers have the ability to specify how a product they order is to be custom configured. Given that many products have numerous configurable options, the illustrative embodiments recognize that the total number of possible custom configurations is staggering. The illustrative embodiments recognize that the products being manufactured in present manufacturing environments are often not uniformly configured for this and many other reasons.

The illustrative embodiments recognize that sampling non-uniformly configured or custom configured products for quality and other testing is a difficult task. For example, using the linear sampling of each n-th product allows many uniquely configured products to escape the testing. Using random sampling also fails with customized products for a similar reason.

On the other end of the spectrum, the illustrative embodiments also recognize that sampling each custom configured product is also problematic. For example, selecting and subjecting each custom configured or non-uniformly configured product is an expensive proposition with disproportionately low yield value.

Furthermore, the illustrative embodiments recognize that not all product configurations warrant sampling and testing. For example, if a configuration is non-standard but is produced in sufficient quantities, sampling each product of that configuration is overkill but the quantities may be produced in such a manner that linear or random sampling may not sample any product from those quantities.

The illustrative embodiments recognize that different configurations have associated therewith different risk factors, and therefore have different risks. Different risks warrant different levels of sampling. The illustrative embodiments recognize that present sampling methods for sampling manufactured products are inadequate to accomplish a risk-based sampling of custom configured or non-uniformly configured products.

The illustrative embodiments used to describe the invention generally address and solve the above-described problems and other problems related to sampling products for testing or assessment in manufacturing processes. The illustrative embodiments provide a method, system, and computer program product for dynamic risk assessment based product sampling.

According to the illustrative embodiments, a risk is measurement of an event occurring out of defined bounds in the processing flow of a product that has been ordered. The risk associated with a custom configured product or non-standard configuration product is a value, which in some instances can be a probabilistic value, to wit, a probability that the event will occur or not occur in the processing flow of the product during manufacturing.

The manufacturer or another entity associated with fulfilling the order for the product may have a threshold level of risk that they would tolerate for that product. The measured or computed risk associated with the product can be compared with that threshold risk value to determine whether the producing, manufacturing, and/or delivering (hereinafter collectively referred to as “delivery” or “delivering”) the product under a given set of circumstances entails exceeding that tolerable risk level. If the risk associated with the product exceeds the threshold risk value under the given set of circumstances that affect the manufacturing or delivery of the product under default order fulfillment conditions or conditions specified by the customer, the product should be selected in the sampling.

A processing flow for delivering a product comprises steps or stages, which for example include but are not limited to order entry, order processing, materials procurement, materials delivery, manufacturing equipment scheduling, skills availability and scheduling, assembly process configuration, testing process configuration, transportation availability and scheduling, shipping, delivery to the customer. A processing flow can implement variations of these example stages, and other implementation-specific stages.

Further according to the illustrative embodiments, the processing flow of the ordered product can be affected by a variety of circumstances. A product-specific circumstance is a circumstance caused by, related to, a result of, or otherwise associated with the custom configuration of the product and adversely affects the custom configured product or delivery thereof. For example, a product-specific circumstance affecting a stage in the processing flow of delivering a product may be that the product requires a specific non-standard component, which may be unavailable.

An aggregate circumstance is a circumstance that is caused by, related to, a result of, or otherwise associated with the delivery of products in general and affects the delivery of several products including the custom configured product. As an example, an aggregate circumstance affecting a stage in the processing flow of delivering a product may be that a common component used in a variety of configurations is unavailable. As another example, an aggregate circumstance may be that some manufacturing equipment used for a manufacturing step has broken down. Late delivery of parts, missing parts, non-compliant part or procedure, non-availability of skilled person or equipment, and the like can each be product-specific or aggregate circumstance depending upon the part, person, procedure, or equipment involved and the affected product(s).

An effect of a circumstance when used in a risk model is referred to as a failure mode. A risk model according to the illustrative embodiments is a method, an algorithm, a code, a pseudo-code, or logic in any suitable form, to compute a risk value. A risk model computes a risk value given a set or a subset of circumstances. For example, an example risk model is implemented as a function that can be called to compute a risk value for an order (or the product in the order) when a part needed in the product is unavailable. Only for the purposes of the example, assume that the unavailable part is product specific, making the circumstance a product-specific circumstance.

The failure mode from the part unavailability circumstance is late delivery of the product. The failure mode is weighted by other factors. For example, a late delivery may be inconsequential if the customer who ordered the product imposes no contractual delivery obligations on the manufacturer, but may cause a penalty assessment on the manufacturer if the there is a contractual obligation to deliver the product by a certain date. Some examples of weighting factors for a failure mode include but are not limited to contractual obligations, service-level agreements (SLA), financial consequences, legal consequences, customer satisfaction, installation cost overrun, excess cost of expedited shipment, consequential costs, and many others. According to the illustrative embodiments, a weighting factor can be a numeric value, a value selected from a scale or range, a Boolean value, or a combination thereof.

A risk model according to the illustrative embodiments computes a risk value for an order or product by using a subset of circumstances in the logic of the risk mode. The risk model determines a failure mode or selects a failure mode from a set of predetermined failure modes based on the computation. The risk model computes a risk value by applying a weighting factor to each of one or more failure modes that may result.

For a given order for a product, an embodiment determines a processing flow for delivering the product, and the stages in that processing flow. For a stage in the processing flow, an embodiment identifies the set of circumstances affecting the stage, and therefore affecting the operations towards the product in that stage, at the time that stage is expected to execute for delivering the product.

An embodiment selects one or more risk models from a set of pre-created risk models that are applicable to the stage and at least a subset of the set of circumstances. The embodiment uses the applicable subset of circumstances in a selected risk model to compute a failure mode. The embodiment weights the failure mode according to the specifics of the order or the product, and computes a risk value.

When more than one risk models are applicable to the stage and the set of circumstances, an embodiment computes several risk values from several risk models in a similar manner. The embodiment computes a total risk value for the stage of the processing flow for the order or product. An embodiment similarly computes risk values for any number or types of stages of the processing flow in a similar manner.

The threshold risk value can be an aggregate threshold risk value or a product-specific threshold risk value. An aggregate threshold risk value is applicable to products of several configurations. A product-specific threshold risk value is applicable to a custom configured or non-uniformly configured product in an order.

An embodiment determines if the risk value at a stage of a processing flow of an order or product exceeds a threshold risk value. Depending on which threshold risk value is exceeded, in which stage the threshold risk value is exceeded, and by how much the threshold risk value is exceeded, an embodiment makes a sampling determination on the order or product.

For example, an embodiment evaluates the difference between the risk value and the threshold risk value according to some rule, policy, or logic to conclude whether the product of the order should be sampled for quality or other testing. If the embodiment determines that the product should be sampled, the product is selected as a sample for testing or other purposes, otherwise not.

Operating in this example manner, an embodiment provides dynamic risk assessment based product sampling. Because the circumstances can change from time-to-time and product-to-product, the sampling determination made by an embodiment is dynamic in nature.

For example, if two identically custom configured products were to be delivered on two separate times, their respective processing flows, stages, circumstances, failure modes, and risk values, or some combination thereof, could be different from one another. Accordingly, an embodiment might select one of the two identical products for sampling according to the risks associated with that product, but not the other according to the different risks associated with the other product.

The illustrative embodiments are described with respect to certain orders, products, processes, stages, operations, models, failure modes, weighting factors, circumstances, risks, risk values, thresholds, logic, rules, policies, algorithms, data processing systems, environments, components, and applications only as examples. Any specific manifestations of such artifacts are not intended to be limiting to the invention. Any suitable manifestation of data processing systems, environments, components, and applications can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments.

Furthermore, a particular illustrative embodiment may have some, all, or none of the advantages listed above.

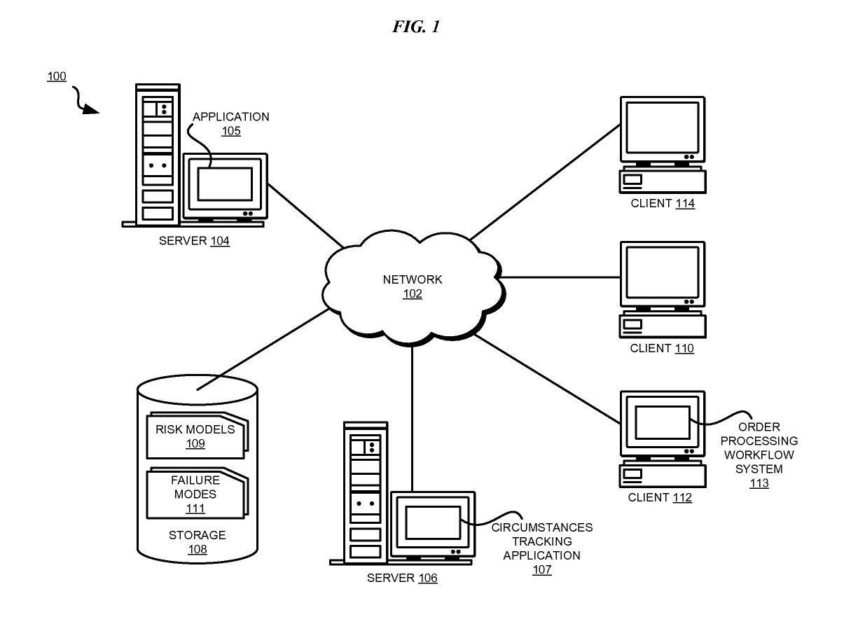

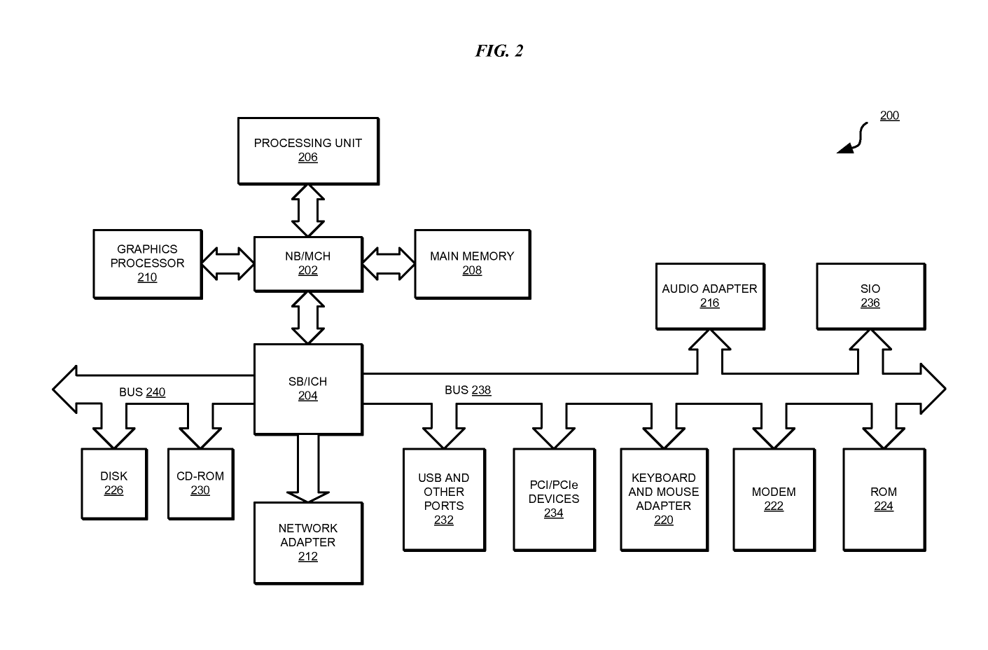

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables. Server 104 and server 106 couple to network 102 along with storage unit 108. Software applications may execute on any computer in data processing environment 100.

In addition, clients 110, 112, and 114 couple to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments.

Application 105 implements one or more embodiments described herein. Tracking application 107 tracks circumstances, which affect stages of processing flows, as they transpire in a supply-chain environment. Tracking application 107 detects, identifies, receives information about, or otherwise tracks one or more aggregate circumstance, one or more product-specific circumstances, or a combination thereof. Order processing workflow system 113 is any suitable system that is usable to identify a processing flow for an order or an ordered product, including the stages for delivering the product. Set 109 is a set of risk models. A risk model in set 109 can be user-created or machine-learned within the scope of the illustrative embodiments. Set 111 is a set of failure modes. A failure mode in set 111 can be user-created or machine-learned within the scope of the illustrative embodiments.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as servers 104 and 106, or clients 110, 112, and 114 in FIG. 1, or another type of device in which computer usable program code or instructions implementing the processes may be located for the illustrative embodiments. Data processing system 200 is also representative of a system or a configuration therein, such as system 113 in FIG. 1 in which computer usable program code or instructions implementing the processes of the illustrative embodiments may be located. Data processing system 200 is described as a computer only as an example, without being limited thereto. Implementations in the form of system 113 in FIG. 1 may modify data processing system 200 and even eliminate certain depicted components there from without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system such as AIX® (AIX is a trademark of International Business Machines Corporation in the United States and other countries), Microsoft® Windows® (Microsoft and Windows are trademarks of Microsoft Corporation in the United States and other countries), or Linux® (Linux is a trademark of Linus Torvalds in the United States and other countries). An object oriented programming system, such as the Java™ programming system, may run in conjunction with the operating system and provides calls to the operating system from Java™ programs or applications executing on data processing system 200 (Java and all Java-based trademarks and logos are trademarks or registered trademarks of Oracle Corporation and/or its affiliates).

Instructions for the operating system, the object-oriented programming system, and applications or programs, such as application 111, diagnostic application 136, or local diagnostic application 105 in FIG. 1, are located on storage devices, such as hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a PDA.

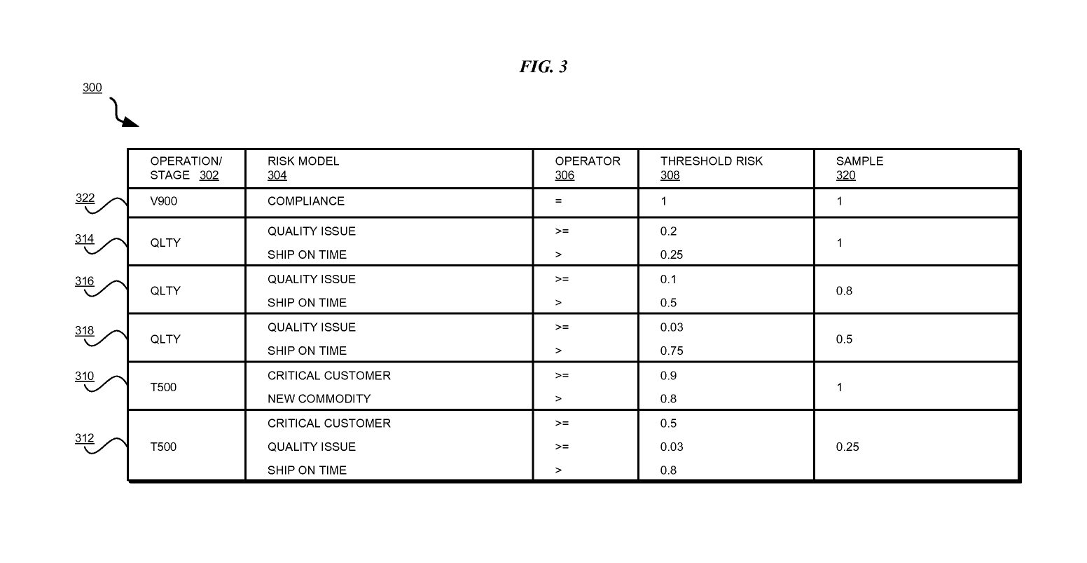

With reference to FIG. 3, this figure depicts an example table correlating example processing flow stages with example risk models for dynamic risk assessment based product sampling in accordance with an illustrative embodiment. One or more rows of table 300, or another similarly purposed representation of the correlation, can be implemented using application 105 in FIG. 1.

Only as an example and without implying any limitation thereto, FIG. 3 depicts the correlation between processing flow stages, or operations in a processing flow, and one or more risk models in tabular form 300. For example, column 302 lists one or more operations that are usable in one or more processing flows, including but not limited to a processing flow to process an order for a custom configured product. Column 304 lists combinations of one or more risk models that are applicable to a corresponding operation in column 302. Column 306 lists an operator or computation that applies to a risk model in column 304 and a threshold risk value in column 308.

An operation in column 302 can have different sets or combinations of risk models associated therewith. For example, row 310 of table 300 indicates that example stage “T500” can have risk models “Critical customer,” “New commodity,” or both apply under certain circumstances. Row 312 indicates that the same example stage “T500” can have risk models “Critical customer,” “Quality issue,” “Ship on time,” or some combination of one or more of the three example risk models apply under certain other circumstances.

An operation in column 302 can have the same set or combination of risk models associated therewith but with different threshold risk value combinations. For example, rows 314, 316, and 318 of table 300 indicates that example stage “QLTY” has risk models “Quality issue,” “Ship on time,” or both apply under certain circumstances. For example, in one embodiment, for an order or product, row 314 indicates that if the risk value computed by the “Quality issue” risk model is greater than or equal to 0.2 (based on the operator in column 306 and threshold risk value in column 308 of row 314 shown aligned with the “Quality issue” risk model), and the risk value computed by the “Ship on time” risk model is greater than 0.25 (based on the operator in column 306 and threshold risk value in column 308 of row 314 shown aligned with the “Ship on time” risk model), the risk associated with the order or product for which the risk models are executed should be sampled at or after the “QLTY” stage.

Alternatively, for the order or product, row 316 indicates that if the risk value computed by the “Quality issue” risk model is greater than or equal to 0.1, and the risk value computed by the “Ship on time” risk model is greater than 0.5, the order or product for which the risk models are executed should be sampled at or after the “QLTY” stage. Alternatively, for the order or product, row 318 indicates that if the risk value computed by the “Quality issue” risk model is greater than or equal to 0.03, and the risk value computed by the “Ship on time” risk model is greater than 0.75, the order or product for which the risk models are executed should be sampled at or after the “QLTY” stage.

An embodiment (shown using optional sampling column 320) is also applicable where the sampling is rate-based, to wit, where the samples are selected at a certain frequency. Taking rows 314, 316, and 318 as examples, and when rate-based sampling is in use, if the risk value computed by the “Quality issue” risk model is greater than or equal to 0.2 and the risk value computed by the “Ship on time” risk model is greater than 0.25 as in row 314, the sampling rate should be changed to sampling each product at or after the “QLTY” stage according to the entry in column 320.

However, if the risk value computed by the “Quality issue” risk model is greater than or equal to 0.1 and the risk value computed by the “Ship on time” risk model is greater than 0.5 as in row 316, the sampling rate should be changed to sampling eighty percent of the products at or after the “QLTY” stage according to the entry in column 320. And, if the risk value computed by the “Quality issue” risk model is greater than or equal to 0.03 and the risk value computed by the “Ship on time” risk model is greater than 0.75 as in row 318, the sampling rate should be changed to sampling half the products at or after the “QLTY” stage according to the entry in column 320.

Some risk models can evaluate a Boolean risk value. For example, row 322 shows that if the risk value computed by the “Compliance” risk model is 1 (out of compliance=True or 1, in compliance=False or 0), the order or product for which the risk models are executed should be sampled at or after the “QLTY” stage. Where the sampling is rate-based, an embodiment suggests sampling every product according to the entry in column 320 in row 322 if the risk value computed by the “Compliance” risk model is 1 or True.

The example tabular organization, the example stages or operations, the example risk models or their combinations, the example operators and threshold risk values depicted in FIG. 3 are not intended to be limiting. From this disclosure, those of ordinary skill in the art will be able to conceive other variations of these and other similarly purposed artifacts and adapt an embodiment to use them, and the same are contemplated within the scope of the illustrative embodiments.

A risk model, such as risk model “Compliance” or “Quality issue,” comprises suitable logic to compute an output risk value using values obtained for one or more circumstances, such as from tracking application 107 in FIG. 1. Such logic is implementation specific and therefore not shown here but is contemplated within the scope of the illustrative embodiments.

For example, which circumstances affect which product, to what degree, in combination with which other circumstances, depends not only on the product's configuration but also on the manufacturing facility's configuration, equipment, personnel, upstream and downstream supply-chain dependencies, and many other factors. The descriptions of one or more embodiments described herein are sufficient to enable those of ordinary skill in the art to arrange all such factors into logic, such as in computer usable code, to compute risk values in their specific supply-chain environments.

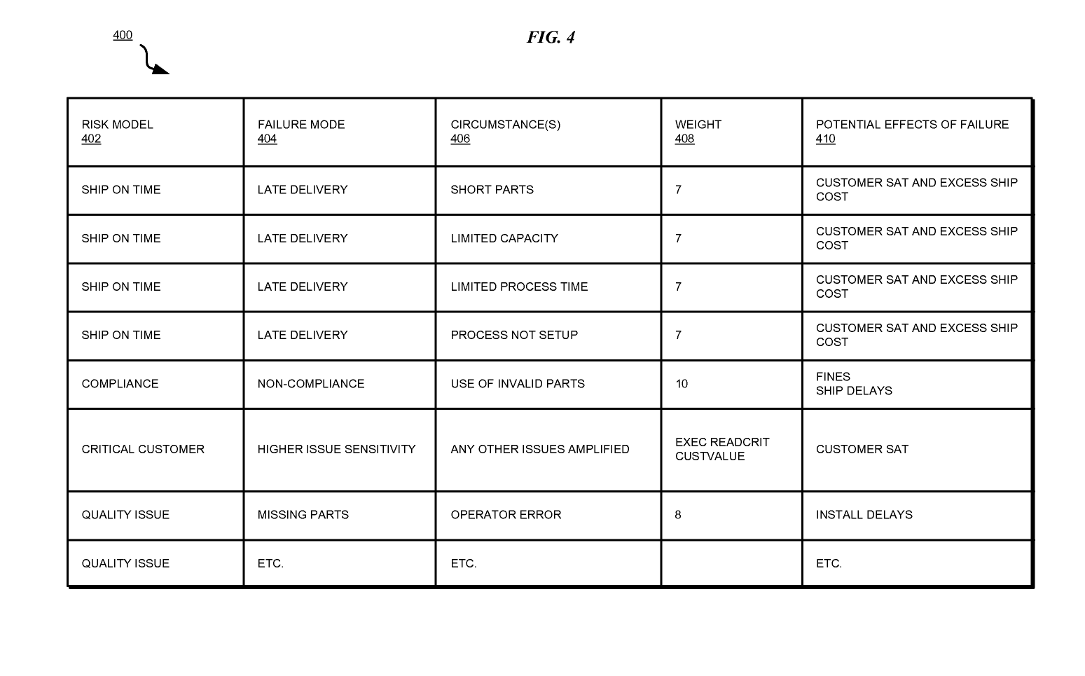

With reference to FIG. 4, this figure depicts an example tabular representation of correlations between circumstances, risk models, and failure modes usable for dynamic risk assessment based product sampling in accordance with an illustrative embodiment. One or more rows of table 400, or another similarly purposed representation of the correlation can be implemented using application 105 in FIG. 1.

As an example, column 402 lists various risk models, such as risk models depicted and described with respect to FIG. 3, or risk models in set 109 in FIG. 1. Column 404 lists various failure modes, such as failure modes in set 111 in FIG. 1, associated with the corresponding risk model in the same row. Column 406 lists the one or more circumstances under which the risk model of a row is associated with the failure mode in that row failure modes. For example, an embodiment uses a value associated with a circumstance in column 406 for computing a risk value from the risk model in column 402 of the same row.

Tracking application 107 produces such values for the circumstances of column 406. Some examples of values for example circumstances include but are not limited to—“short parts” can be represented as number of parts short, number of parts above or below a number limit, percentage of shortage; “limited capacity” (of equipment, space, or person) expressed as numeric capacity, percentage capacity, capacity value above or below a capacity level; “limited process time” (of equipment, space, or person) expressed as numeric amount of time, percentage amount of time, amount of time above or below an amount level; “process not setup” (of equipment or person) expressed as a Boolean value, completion percentage of the setup; “use of invalid parts” expressed as a Boolean value, text string describing the part as different from a valid part, e.g., using a part number that is incorrect; and so on.

The example circumstances and the example manners of representing them are not intended to be limiting on the illustrative embodiments. From this disclosure, those of ordinary skill in the art will be able conceive many other circumstances and representations thereof, and the same are contemplated within the scope of the illustrative embodiments.

Column 408 lists one or more weights associated with the corresponding one or more failure modes in column 404 in the same row. Optional column 410 includes factors that contribute to the weight listed in column 408 of a given row.

Consider row 412 as an example. Risk model “ship on time” depends on or uses circumstance “short parts” and has a failure mode “late delivery” whose weight is 7 (on an example scale of 1-10), because of the resulting decrease in “customer satisfaction” and the “excess shipping cost” from the late delivery. Using the information contained in row 412, and circumstance values obtained from tracking application 107 of FIG. 1, an embodiment, such as an embodiment implemented in application 105 in FIG. 1, computes a risk value. The computed risk value is applicable to a stage listed in column 302 in FIG. 3, and the application determines using a corresponding threshold risk value in column 308 in FIG. 3, whether the order or product in question should be sampled, or whether the sampling process should be altered in another manner.

The application uses other rows and columns of table 400 in a similar manner in conjunction with the rows and columns of table 300 in FIG. 3 to perform dynamic risk assessment based product sampling. The changing values of the circumstances of column 406 impart the dynamic nature of the risk-based sampling adjustment performed by the application. Therefore, selecting an order or product for sampling, or performing a particular adjustment to another sampling method under one set of circumstances or at one time or place may not be applicable to a similar order, product, or sampling method at a different time, place, or under different circumstances.

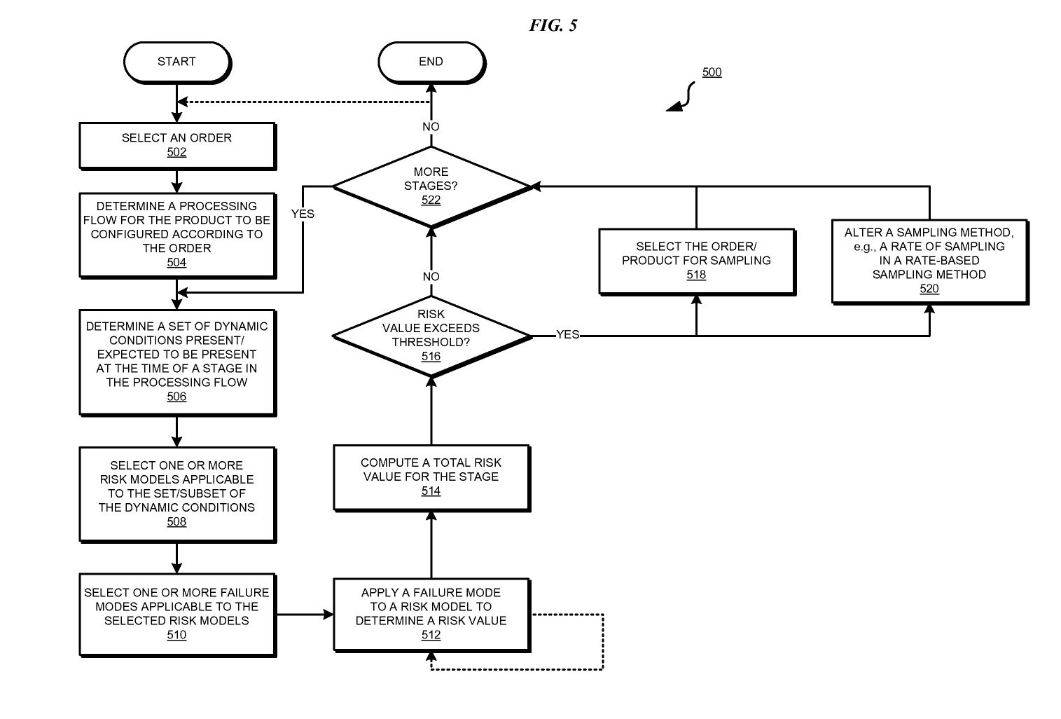

With reference to FIG. 5, this figure depicts a flowchart of an example process for dynamic risk assessment based product sampling in accordance with an illustrative embodiment. Process 500 can be implemented in application 105 in FIG. 1.

The application selects an order, or a product in an order (block 502). The application determines a processing flow for the product to be configured according to the order (block 504).

The application determines a set of dynamic conditions or circumstances that are present or are expected to be present at the time a stage in the processing flow is executed (block 506). The application selects one or more risk models applicable to the set of the dynamic circumstances or a subset thereof (block 508).

The applications elects one or more failure modes applicable to the selected risk models (block 510). The application applies a failure mode to a risk model to compute a risk value, such as by suitably weighting the failure mode in the risk model computation (block 512). The application executes as many risk models as may be selected in block 508, using the same or different subsets of the set of dynamic circumstances determined in block 506 and as many weighted failure modes as may be selected in block 510.

The application computes a total risk value for the stage identified in block 506 (block 514). For example, according to one embodiment, the application averages all the different risk values computed in the various executions of block 512. According to another example embodiment, the application computes a total risk value for the stage by applying all the different risk values computed in the various executions of block 512 to an implementation-dependent formula. Generally, the total risk value of block 514 can be computed using the risk values computed in the various executions of block 512 according to any formula suitable for a given implementation.

The application determines whether the total risk value for the stage (stage risk value) exceeds a threshold risk value (block 516). If the total risk value for the stage does not exceed the threshold risk value (“No” path of block 518), the application proceeds to block 522. If the total risk value for the stage exceeds the threshold risk value (“Yes” path of block 518), the application performs one or both of blocks 518 and 520 depending upon the order, the sampling method, and the product being delivered. For example, the application selects the order or the product therein for sampling (block 518). Alternatively, or in addition to block 518, the application alters a sampling method, e.g., by changing a rate in a rate-based sampling method (block 520). Within the scope of the illustrative embodiments, blocks 518 and 520 can be configured to occur prior to the execution of the stage identified in block 506, during the stage, or after the execution of the stage is completed.

The application determines whether more stages are to be assessed for dynamic risk assessment based product sampling (block 522). If more stages in the processing flow are to be assessed (“Yes” path of block 522), the application returns to block 506 to select another stage. If no more stages in the processing flow are to be assessed (“No” path of block 522), the application either ends process 500 thereafter or returns process 500 to block 502 to select another order or product for dynamic risk assessment based product sampling.

Thus, a computer implemented method, system or apparatus, and computer program product are provided in the illustrative embodiments for dynamic risk assessment based product sampling.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for dynamic risk assessment based product sampling, the method comprising:
determining, for a product to be produced in response to an order for the product, a processing flow comprising a plurality of stages for producing the product;
identifying a set of conditions expected to be present at a time of executing a stage in the plurality of stages;
selecting a risk model corresponding to a subset of the set of conditions;
selecting a failure mode related to the risk model;
applying, using a processor and a memory, the failure mode to the risk model using the subset of conditions to compute a risk value associated with the product; and
selecting the product as a sample for the stage responsive to the risk value exceeding a threshold risk value.

2. The method of claim 1, further comprising:
applying, for a second product to be produced in response to a second order, to compute a second risk value, a second failure mode to a second risk model using a second set of conditions expected to exist at the stage in the processing flow,
wherein the second product is not selected as the sample for the stage responsive to the second risk value not exceeding a second threshold risk value.

3. The method of claim 1, further comprising:
applying, to compute a second risk value, a second failure mode to a second risk model using a second subset of the set of conditions; and
computing a stage risk value for the stage using the risk value and the second risk value, wherein the selecting the product as the sample is responsive to the stage risk value exceeding a threshold stage risk value.

4. The method of claim 1, further comprising:
determining a weight of each failure mode, wherein applying the failure mode to the risk model under the subset of conditions comprises applying a weight corresponding to the failure mode.

5. The method of claim 1, further comprising:
selecting a set of risk models, the set of risk models including the risk model, wherein a second risk model in the set of risk models corresponds to a second subset of the set of conditions.

6. The method of claim 5, further comprising:
selecting a set of failure modes related to the set of risk models, the set of failure modes including the failure mode, wherein at least one failure mode in the set of failure modes corresponds to at least one risk model in the set of risk models.

7. The method of claim 1, further comprising:
determining a value of each condition in the set of conditions expected at the time, wherein a first value of a first condition in the set of conditions changes to a second value of the first condition at a second time.

8. The method of claim 1, wherein a condition in the set of conditions occurs at a location other than a manufacturing facility, wherein one portion of the processing flow occurs at the manufacturing facility and another portion of the processing flow occurs at the location.

9. The method of claim 1, wherein the order causes the product to be configured differently from a second product.

10. A computer readable article of manufacture tangibly embodying a computer readable instructions which, when executed, cause a computer to carry out steps of a method for dynamic risk assessment based product sampling, the method comprising:
determining, for a product to be produced in response to an order for the product, a processing flow comprising a plurality of stages for producing the product;
identifying a set of conditions expected to be present at a time of executing a stage in the plurality of stages;
selecting a risk model corresponding to a subset of the set of conditions;
selecting a failure mode related to the risk model;
applying the failure mode to the risk model using the subset of conditions to compute a risk value associated with the product; and
selecting the product as a sample for the stage responsive to the risk value exceeding a threshold risk value.

11. The article of manufacture of claim 10 embodying instructions which, when executed, cause the computer to carry out the method further comprising:
applying, for a second product to be produced in response to a second order, to compute a second risk value, a second failure mode to a second risk model using a second set of conditions expected to exist at the stage in the processing flow; and
wherein the second product is not selected as the sample for the stage responsive to the second risk value not exceeding a second threshold risk value.

12. The article of manufacture of claim 10 embodying instructions which, when executed, cause the computer to carry out the method further comprising:
applying, to compute a second risk value, a second failure mode to a second risk model using a second subset of the set of conditions; and
computing a stage risk value for the stage using the risk value and the second risk value, wherein the selecting the product as the sample is responsive to the stage risk value exceeding a threshold stage risk value.

13. The article of manufacture of claim 10 embodying instructions which, when executed, cause the computer to carry out the method further comprising:
determining a weight of each failure mode, wherein applying the failure mode to the risk model under the subset of conditions comprises applying a weight corresponding to the failure mode.

14. The article of manufacture of claim 10 embodying instructions which, when executed, cause the computer to carry out the method further comprising:
selecting a set of risk models, the set of risk models including the risk model, wherein a second risk model in the set of risk models corresponds to a second subset of the set of conditions.

15. The article of manufacture of claim 14 embodying instructions which, when executed, cause the computer to carry out the method further comprising:
selecting a set of failure modes related to the set of risk models, the set of failure modes including the failure mode, wherein at least one failure mode in the set of failure modes corresponds to at least one risk model in the set of risk models.

16. The article of manufacture of claim 10 embodying instructions which, when executed, cause the computer to carry out the method further comprising:
determining a value of each condition in the set of conditions expected at the time, wherein a first value of a first condition in the set of conditions changes to a second value of the first condition at a second time.

17. The article of manufacture of claim 10, wherein a condition in the set of conditions occurs at a location other than a manufacturing facility, wherein one portion of the processing flow occurs at the manufacturing facility and another portion of the processing flow occurs at the location.

18. The article of manufacture of claim 10 further embodying transferring instructions which, when executed, cause the computer to carry out the method further comprising:
transferring over a network from a remote data processing system, the computer readable instructions; and
storing, responsive to the transferring, the computer readable instructions in a data processing system.

19. The article of manufacture of claim 10 further embodying downloading instructions which, when executed, cause the computer to carry out the method further comprising:
downloading, from a server data processing system where the computer usable instructions are stored, over a network to a remote data processing system, the computer readable instructions for use in a computer readable storage device associated with the remote data processing system.

20. A data processing system for dynamic risk assessment based product sampling, the data processing system comprising:
a storage device including a storage medium, wherein the storage device stores computer usable program code; and
a processor, wherein the processor executes the computer usable program code, and wherein the computer usable program code comprises:
computer usable code for determining, for a product to be produced in response to an order for the product, a processing flow comprising a plurality of stages for producing the product;
computer usable code for identifying a set of conditions expected to be present at a time of executing a stage in the plurality of stages;
computer usable code for selecting a risk model corresponding to a subset of the set of conditions;
computer usable code for selecting a failure mode related to the risk model;
computer usable code for applying the failure mode to the risk model using the subset of conditions to compute a risk value associated with the product; and
computer usable code for selecting the product as a sample for the stage responsive to the risk value exceeding a threshold risk value.
